(19) United States
(12) Patent Application Publication
(10) Pub. No.: US 2017/0059042 A1
(43) Pub. Date: Mar. 2, 2017

(54) SEALING SYSTEMS AND RELATED METHODS

(71) Applicant: Coldwater Group, Inc., Atlanta, GA (US)

(72) Inventors: William David Withers, Atlanta, GA (US); Thomas S. Gardner, Acworth, GA (US); John O. Statham, Mableton, GA (US)

(21) Appl. No.: 15/042,193

(22) Filed: Feb. 12, 2016

Related U.S. Application Data
(60) Provisional application No. 62/211,137, filed on Aug. 28, 2015.

(51) Int. Cl. F16J 15/3296; F16J 15/324; D21F 1/48; F16J 15/3244

(52) U.S. Cl. CPC F16J 15/3296; F16J 15/3244; F16J 15/324; D21F 1/48

(57) ABSTRACT

Sealing systems and related methods are provided. In this regard, a representative sealing system includes: an elongated seal having a contact surface configured to form an airtight seal with an inner surface of the drum; contact sensor circuitry configured to provide an electrical signal containing information indicative of direct contact between the seal and the inner surface of the drum; and a control actuator configured to direct a flow of lubricant responsive to receiving the information from the contact sensor indicating direct contact such that the flow of lubricant forms a film of lubricant between the contact surface and the inner surface of the drum to prevent direct contact between the seal and the drum.

### CROSS REFERENCE TO RELATED APPLICATION

This utility application claims the benefit of and priority to U.S. Provisional application 62,211,137, filed on 28 Aug. 2015, the entire contents of which are incorporated by reference herein.

### TECHNICAL FIELD

The present disclosure generally relates to paper manufacturing.

### DESCRIPTION OF THE RELATED ART

Paper machines (i.e., machines for manufacturing tissue, cardboard, newspaper, and the like) typically incorporate a suction roll for drawing off liquids from a liquid-laden pulp substrate that is carried through the machinery by a carrying wire or mat. Such a suction roll includes a rotating shell and a stationary vacuum box located within the shell. As the shell rotates around the vacuum box, vacuum pressure draws liquid (e.g., water) from the pulp substrate through holes in the suction roll and toward the vacuum box.

Transferring the vacuum in the vacuum box through the holes in the rotating shell typically involves the use of one or more axially-extending seals located between the stationary box and the rotating shell. Such a seal typically is washed with lubricant to prevent the seal from contacting the inner surfaces of the rotating shell in an effort to prolong the life of the seal and prevent drag load on the rotating shell. However, too little lubricant may allow contact with the shell, shortening seal life and increasing the drag load on the shell.

### SUMMARY

Sealing systems and related methods are provided. In this regard, an example embodiment of a sealing system comprises: an elongated seal having a contact surface configured to form an airtight seal with an inner surface of the drum; contact sensor circuitry configured to provide an electrical signal containing information indicative of direct contact between the seal and the inner surface of the drum; and a control actuator configured to direct a flow of lubricant responsive to receiving the information from the contact sensor indicating direct contact such that the flow of lubricant forms a film of lubricant between the contact surface and the inner surface of the drum to prevent direct contact between the seal and the drum.

An example embodiment of a sealing method comprises: monitoring locations of a seal formed between a sealing element and an inner surface of a rotatable perforated drum; receiving information indicative of direct contact between the sealing element and the inner surface; and responsive to the information, directing lubrication to a vicinity of the seal to alleviate the direct contact.

Another example embodiment of a sealing method comprises: providing a first zone of a seal formed between a sealing element and an inner surface of a rotatable perforated drum; providing a second zone of the seal, wherein the first zone and the second zone are not coextensive; and selectively dispensing lubrication to at least one of the first zone and the second zone.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of an example embodiment of a sealing system showing paper being processed between a suction roll and a mating roll.

FIG. 2 is a schematic, cross-sectional view of the embodiment of FIG. 1 as viewed along section line 2-2 (FIG. 1).

FIG. 3 is a partially cut-away, schematic view of an example embodiment of a seal.

FIGS. 4-7 are schematic diagrams of another example embodiment of a sealing system.

FIG. 8 is a schematic diagram of another example embodiment of a sealing system.

FIGS. 9 and 10 are flowcharts depicting functionality associated with example embodiments of a method for sealing.

### DETAILED DESCRIPTION

Reference will now be made in detail to that which is illustrated in the drawings. While the disclosure will be described in connection with these drawings, there is no intent to limit the scope of legal protection to the embodiment or embodiments disclosed herein. Rather, the intent is to cover all alternatives, modifications and equivalents included within the spirit and scope of the disclosure as defined by the appended claims.

As will be described in detail, sealing systems and related methods are provided for sealing at least one underpressure or overpressure area adjoining a surface, which is moved in a movement direction in a paper machine. Typically, such a surface is an inner surface of a perforated drum that is rotatable about a rotational axis. The system typically comprises components that are positioned within an interior chamber of the drum.

In this regard, FIG. 1 is a schematic diagram of an embodiment of a sealing system 10, which includes a suction roll (drum) 14 and a mating roll 16. As shown in FIG. 1, paper 12 is processed between suction roll 14 and mating roll 16, with both rolls rotating (e.g., suction roll 14 rotates about axis 18) to expel paper 12 in the direction of arrow A.

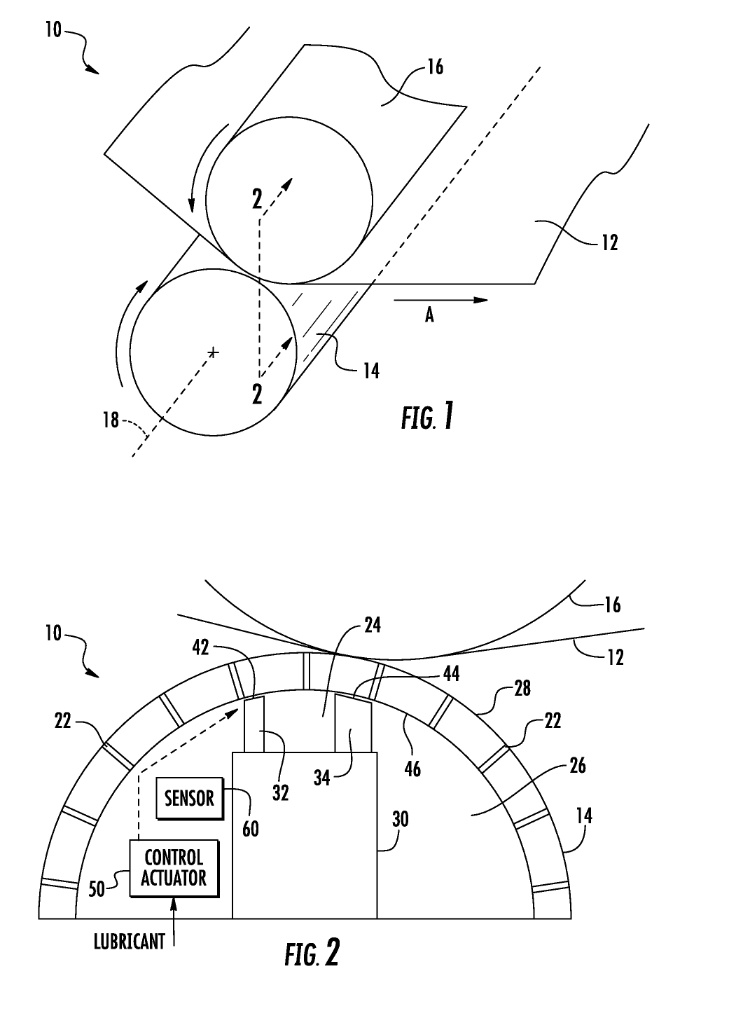

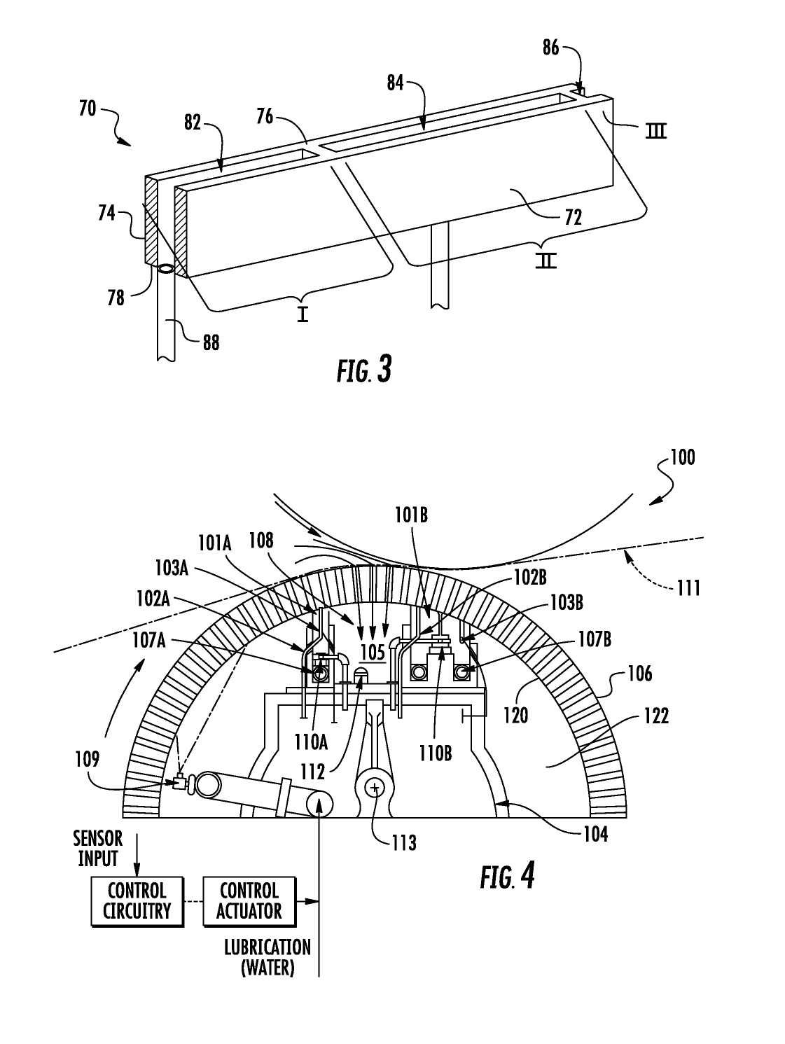

In the cross-sectional view of FIG. 2, it is shown that suction roll 14 incorporates multiple holes or perforations 22 that facilitate the application of vacuum pressure from a vacuum pressure area 24 located within the interior 26 of the suction roll to the paper 12 passing along the exterior surface 28 of the suction roll.

Vacuum pressure is provided by a suction or vacuum box 30 that is mounted within interior 26, with the generated vacuum pressure preferably being confined to vacuum pressure area 24 by seals. In this embodiment, two such seals (32, 34) are provided, each of which includes a corresponding contact surface (42, 44). Each contact surface is configured to form an airtight seal with the inner surface 46 of suction roll 14.

In operation, the seals typically hydroplane on lubricant (e.g., water) that is located between the contact surfaces 42, 44 and the inner surface 46, with the lubricant preferably preventing direct contact between the contact surfaces and the inner surface of the suction roll. The lubricant is directed to the appropriate locations by control actuator 50 that selectively directs the flow of lubricant and/or varies the flow rate of the lubricant. Control actuator 50 may be provided in various forms such as a manually-controlled or automated valve(s), for example.

In some embodiments (such as described in detail later), lubrication can be supplied via a lubrication shower configured to apply lubricant upstream of (in a rotational sense) the contact surface. Additionally or alternatively, lubrication can be provided by a lubrication outlet. Such a lubrication outlet can be positioned along the contact surface of the seal itself and is configured to dispense lubricant. A lubrication passage communicates with the lubrication outlet and is configured to provide the lubrication outlet with a flow of lubricant so that the lubricant dispensed from the lubrication outlet forms a film of lubricant between the contact surface and the inner surface of the drum in a vicinity of the lubrication outlet.

In some embodiments, a lubrication outlet and/or shower may be configured to dispense lubrication associated with one or more zones of the contact surface (i.e., one or more axially extending portions of the contact surface). Moreover, one or more outlets or shower nozzles may be used to selectively provide lubrication to multiple zones.

System 10 of FIG. 2 also incorporates a sensor 60 (e.g., proximity, temperature, pressure and/or vacuum sensor circuitry) positioned to provide an electrical signal containing information indicative of direct contact between one or more of seals 42, 44 and inner surface 46. Control actuator 50 is operative to release or decrease a flow of the lubricant responsive to sensor 60 indicating direct contact between a seal and inner surface 46. In some embodiments, flow rate for the lubricant may be adjusted based on the indication of direct contact.

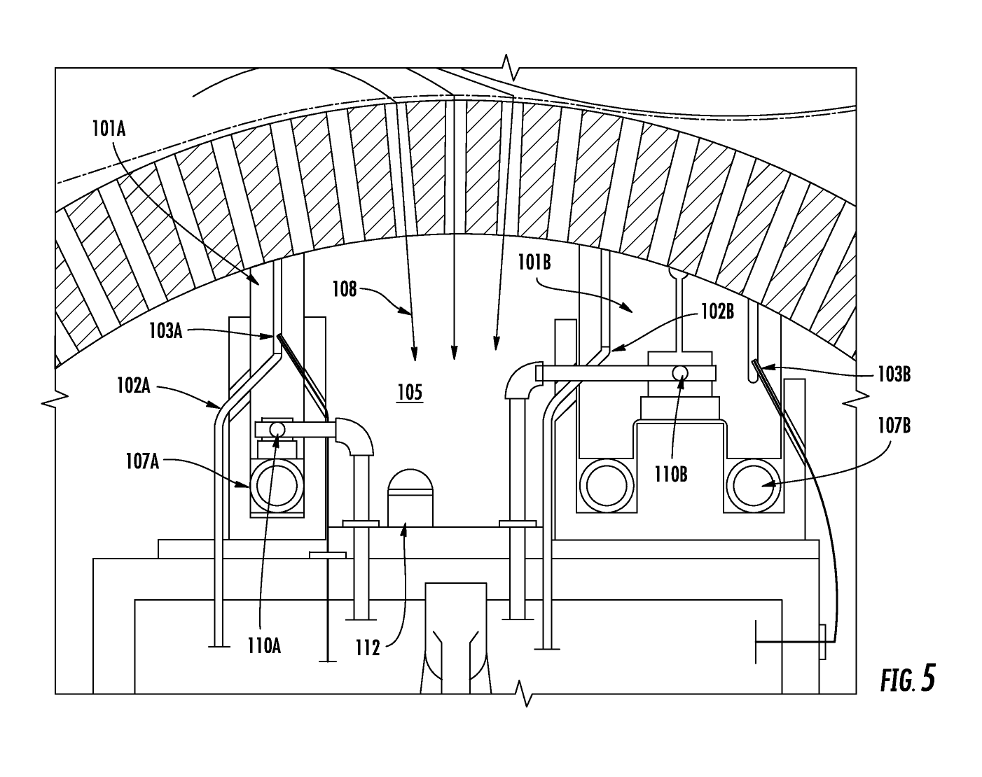

An example embodiment of a seal 70 is depicted in FIG. 3. As shown in FIG. 3, seal 70 is an elongate member that is generally rectangular in cross-section although other configurations may be used in other embodiments. The seal has opposing sidewalls (72, 74), an upper surface 76 (contact surface) and a lower surface 78. Seal 70 also defines multiple non-coextensive zones (e.g., zones I, II and III) that extend along a length of the seal. Each of the zones is serviced by lubricant via a corresponding lubricant outlet (e.g., 82, 84, 86), with a corresponding lubricant conduit feeding one or more of the outlets. By way of example, conduit 88 directs lubricant to zone I via outlet 82.

Another example embodiment of a sealing system is depicted in FIGS. 4-7. It should be noted that the schematic cross-sectional views of FIGS. 4-7 may depicted cross-sections from various axial positions along the rotational axis of the associated rotating shell/drum. However, in other embodiments, the cross-sectional views may vary from each other at different axial positions.

As shown in the FIGS. 4-7, system 100 incorporates at least one sealing element (e.g., seal 101A, 101B) that is located opposite the moved surface 120 and within the interior chamber 122 defined by the drum 106. The sealing element includes at least one sensor (e.g. pressure sensor (102A, 102B), temperature sensor (103A, 103B), proximity sensor (not shown) and/or vacuum sensor 112, among others) to detect any contact between the sealing element and the inner surface of the drum. Responsive thereto, the system provides lubrication to the point or zone of contact, such as by increasing a flow rate of the lubrication to the desired zone.

Sealing system 100 is for use in a suction roll in a paper, tissue or cardboard machine (and may comprise the roll or machine with which it is associated). A stationary suction box 104 forms an airtight seal around a vacuum area 105 and between the rotating, perforated roll shell (drum) 106.

In the depicted embodiment, the sealing elements (101A, 101B) are positioned upon variable tension springs in the form of flexible air tubes (107A, 107B), lightly pressurized so as to position the seal close to the roll shell.

In operation, it is intended that the sealing elements are in light contact with the inner surface of rotating shell during start-up, and wear in to match the profile of the shell in a few hours. From that point in time until the roll stops, water from the process 108 and from various other forms of applied lubrication form the actual seal with the sealing elements hydroplaning on this lubrication along the inside surface 120 of the shell. In this configuration, little additional seal wear typically occurs until the machine stops and the start-up cycle is repeated.

A lubrication shower 109 is often positioned (in a rotational sense) just prior to (i.e., rotationally upstream) one or each of the sealing elements. The shower typically includes one or more nozzles to direct a spray of lubricant. In some embodiments, multiple nozzles are provided and used to direct lubrication toward various zones of a contact surface. By way of example, a series of nozzles could be spaced along the axis 113 of the drum with each being used to selectively direct lubrication to a corresponding zone responsive to sensed conditions. Additionally or alternatively, in some applications, lubrication is directed through one or more lubrication outlets toward the contact surface of the sealing element (101A, 101B).

The science of proper lubrication for providing such a seal is quite complicated. The process water available for lubrication varies with the grade and weight of paper, tissue, or card board, the position of the suction roll in the paper machine, the applied vacuum, the quantity and diameter of shell perforations, the thickness of the shell, the rotational speed of the shell, the fabrics used to carry the sheet of paper 111, tissue or card board on the opposite side of the perforations, and the nip pressures from mating rolls, among others. The inability to properly calculate the amount of process water available for lubrication in any one application has led to additional lubrication being applied liberally across the sealing surface through the various means described above, without knowledge of the actual need. No attempt has been made in the prior art to detect when and where lubrication is actually needed and to apply it accordingly.

For this purpose, control circuitry 130 (FIG. 4) communicates with one or more of the sensors and is operative to release or decrease a flow of the lubricant responsive to receiving information from the contact sensor indicating direct contact between the seal and the drum. In some embodiments, flow rate for the lubricant may be adjusted based on the information received.

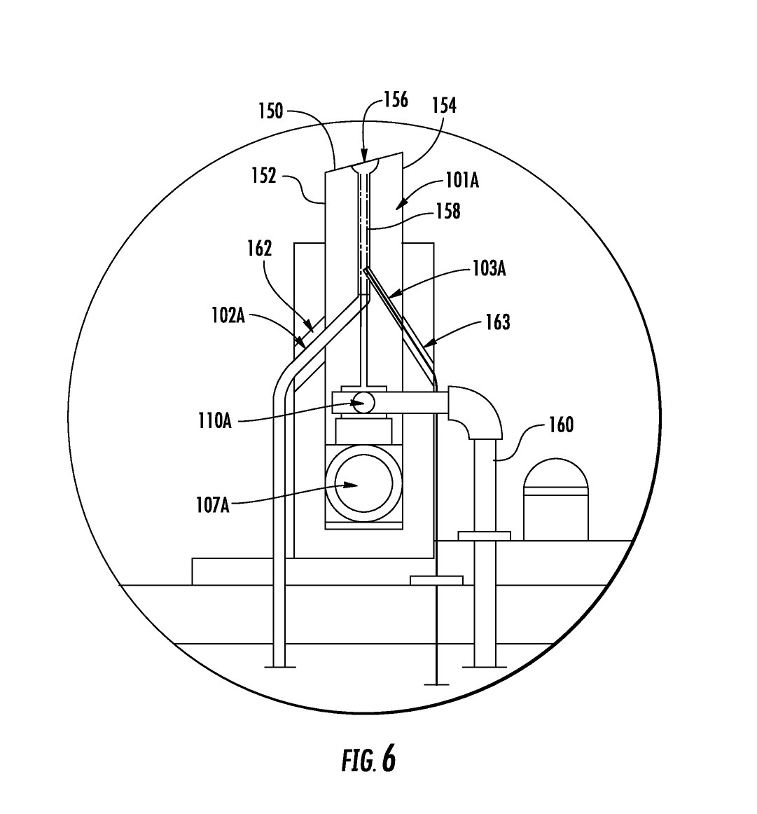

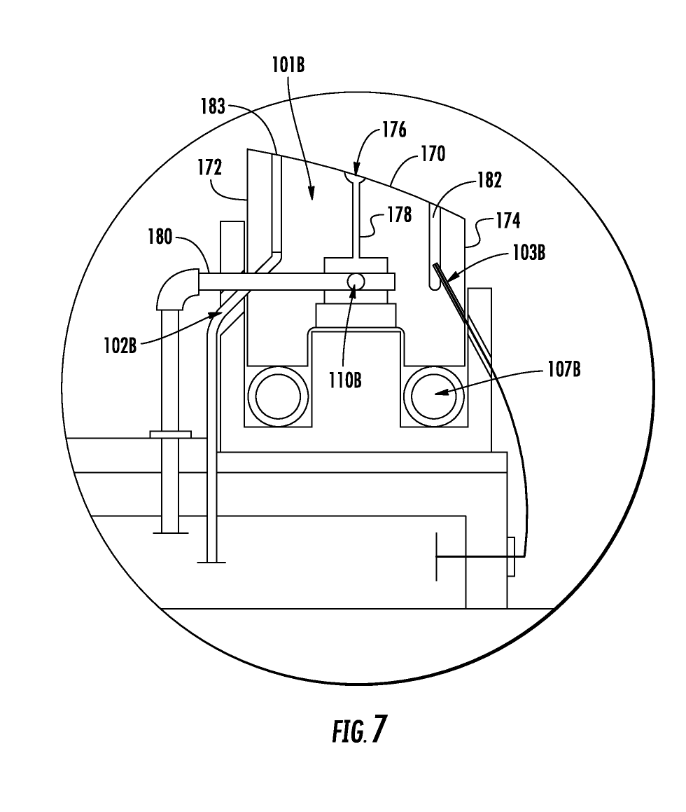

As shown in FIG. 5 (and in greater detail in FIG. 6), sealing element (seal) 101A incorporates a contact surface 150 and sidewalls 152, 154. A lubrication outlet 156 is located at the contact surface that is configured to dispense lubricant provided by a lubrication passage 158. Lubrication passage 158 communicates with the lubrication outlet and is configured to provide the lubrication outlet with a flow of the lubricant so that the lubricant dispensed from the lubrication outlet forms a film of lubricant between the contact surface and the inner surface of the drum in a vicinity of the lubrication outlet. As such, lubrication outlet 156 is configured to dispense lubrication at a first zone of the contact surface. Lubricant is provided to lubrication passage 158 via a conduit 160 that delivers the lubricant to an interior of the seal 101A.

In this embodiment, seal 101A is monitored by pressure sensor 102A and a temperature sensor 103A. Although capable of various configurations (including variations in the number, type and/or placement of sensors), the sensors 102A and 103A are implemented by being mounted within corresponding access passages (162, 163) formed through the sidewalls of the seal that facilitate placement of the sensing components of the sensors within lubrication passage 158.

In some embodiments, a sensor may be mounted at the side of a seal, such as along the lead-in side relative to rotation. The sensor may be positioned at least partially within a groove formed in the surface of the seal, for example. The sensor could be positioned near the seal contact surface to detect heat from wear.

Additionally or alternatively, “wearable” sensors (i.e., sensors configured for wearing away as the seal wears) may be used. For example, a V-shaped wearable sensor may be mounted to a seal, with the difference in distance between any two points on either side of the V being used for determining the corresponding amount of wear of the seal.

As shown in greater detail in FIG. 7, sealing element (seal) 101B incorporates a contact surface 170 and sidewalls 172, 174. A lubrication outlet 176 is located at the contact surface that is configured to dispense lubricant provided by a lubrication passage 178. Lubrication passage 178 communicates with the lubrication outlet and is configured to provide the lubrication outlet with a flow of the lubricant so that the lubricant dispensed from the lubrication outlet forms a film of lubricant between the contact surface and the inner surface of the drum in a vicinity of the lubrication outlet. Lubricant is provided to lubrication passage 178 via a conduit 180 that delivers the lubricant to an interior of the seal 101B.

In this embodiment, seal 101B is monitored by pressure sensor 102B and a temperature sensor 103B. Although capable of various configurations (including variations in the number, type and/or placement of sensors), the sensors 102B and 103B are implemented by being mounted within corresponding access passages (182A, 183A) that open to contact surface 170. Thus, with seal 101B, the sensors (102B, 103B) do not extend into the lubrication passage 178.

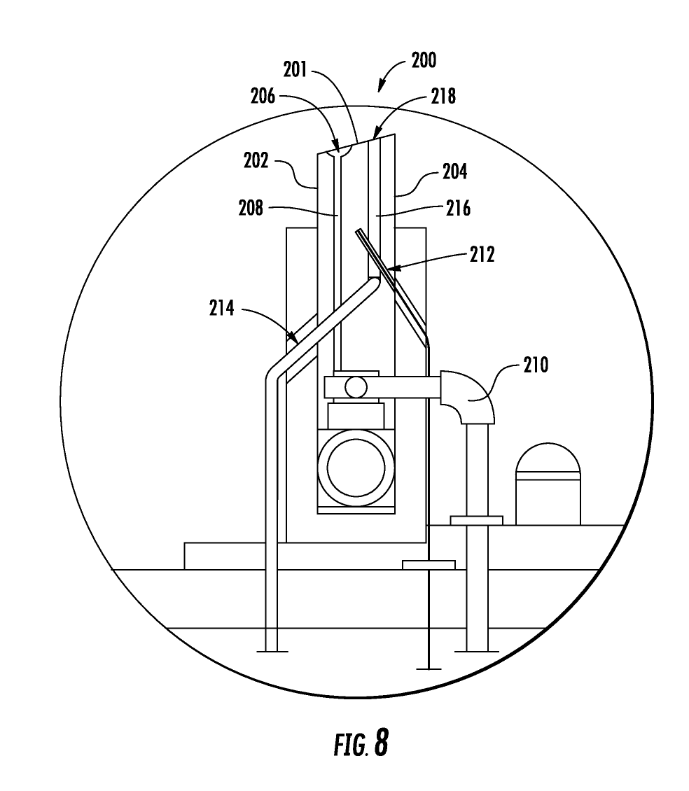

FIG. 8 is a schematic diagram of another example embodiment of a sealing system. As shown in FIG. 8, sealing element (seal) 200 of the system incorporates a contact surface 201 and sidewalls 202, 204. A lubrication outlet 206 is located at the contact surface that is configured to dispense lubricant provided by a lubrication passage 208. Lubrication passage 208 is provided with a flow of lubricant by a conduit 210.

Seal 201 is monitored by multiple sensors (e.g., sensors 212, 214). Although capable of various configurations (including variations in the number, type and/or placement of sensors), the sensors 212 and 214 are implemented by being mounted within a shared access passage 216 that is open to contact surface 201. In some embodiments (such as depicted here), lubrication outlet 206 is positioned at a location of the contact surface rotationally upstream of the opening 218 of access passage 216.

In various embodiments, such as those described herein, a sealing system incorporates contact sensors (such as for pressure and temperature). Pressure and temperature would be detected at various points or zones along the surface of the contact area of the seal with the roll shell. Relative differences in pressure and/or temperature along the length of the seal would indicate areas of contact between the seal and the roll shell. This information would then be used to activate lubrication to the point or zone of contact for a determined amount of time, thereby lubricating the contact area to limit the seal wear and prevent heat build-up that can cause the seal material to expand into the shell.

In some embodiments, an additional sensor 112 (as shown in FIG. 3, for example) may be installed in the vacuum zone to monitor the vacuum level in the suction roll. Any undesired reduction in the vacuum level may also result in the activation of additional lubrication so that adequate water was available to form the seal in the event that the seal was far enough from the shell to allow meaningful leakage of vacuum.

By applying lubrication only when and where additionally needed, the amount of lubrication used may be greatly reduced—in some cases, no additional lubrication may be needed after a start-up phase. Use may also reduce any effect the sealing system could have on the power used to turn the roll, as the sealing system may bear on drive load when contact between the seal and shell occurs. By providing lubrication to contact points/zones when needed, the friction from the contact may be reduced thereby reducing any drag load from the sealing system.

As mentioned above, some embodiments involve the use of sensors/detectors for determining whether unwanted contact exists between a sealing element and the inner surface of the shell/drum. In such an embodiment, such a sensor/detector may communicate with a controller (incorporating control circuitry) for implementing various control functions. A manner for implementing such components may involve the use of a computer or processor-based device.

An example embodiment of such a device may include a processing device (processor circuitry), input/output interface circuits, network interface circuitry, a memory, an operating system, and mass storage, with each communicating across a local data bus. Note that the local data bus may be comprised of a plurality of buses.

The processing device may include any custom made or commercially available processor, a central processing unit (CPU) or an auxiliary processor among several processors associated with the mobile device, a semiconductor based microprocessor (in the form of a microchip), a macroprocessor, one or more application specific integrated circuits (ASICs), a plurality of suitably configured digital logic gates, and other electrical configurations comprising circuit elements both individually and in various combinations to coordinate the overall operation of the system.

The non-transitory memory can include any one of a combination of volatile memory elements (e.g., random-access memory (RAM, such as DRAM, and SRAM, etc.)) and nonvolatile memory elements. The memory typically comprises native operating system, one or more native applications, emulation systems, or emulated applications for any of a variety of operating systems and/or emulated hardware platforms, emulated operating systems, etc. In accordance with such embodiments, the components are stored in memory and executed by the processing device.

One of ordinary skill in the art will appreciate that the memory may, and typically will, comprise other components which have been omitted for purposes of brevity. Note that in the context of this disclosure, a non-transitory computer-readable medium stores one or more programs for use by or in connection with an instruction execution system, apparatus, or device.

Network interface circuitry comprises various components used to transmit and/or receive data over a networked environment. When such components are embodied as an application, the one or more components may be stored on a non-transitory computer-readable medium and executed by the processing device.

If embodied in software, it should be noted that each function described herein may represent a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system. The machine code may be converted from the source code, etc. If embodied in hardware, each function may represent a circuit or a number of interconnected circuits to implement the specified logical function(s).

An example embodiment of a controller that may be used in the sealing system of FIGS. 4-7, for example, may perform the functionality associated with receiving information indicative of contact between the sealing element and the inner surface, such as from at least a first contact sensor. By way of example, in some embodiments, the sensor may be a temperature sensor and the information received may be indicative of a localized increase in temperature above a predetermined temperature threshold. Responsive to the information, lubrication may be directed by the controller to a vicinity of the seal, such as to the location monitored by the first contact sensor. In some embodiments, this may involve one or more of directing lubrication to a lubrication shower(s) and to a lubrication outlet(s). This may involve various manners of actuation such as automated manipulation of a control actuator (e.g., a valve) responsive to a control signal for directing lubrication from a source of lubrication, among others.

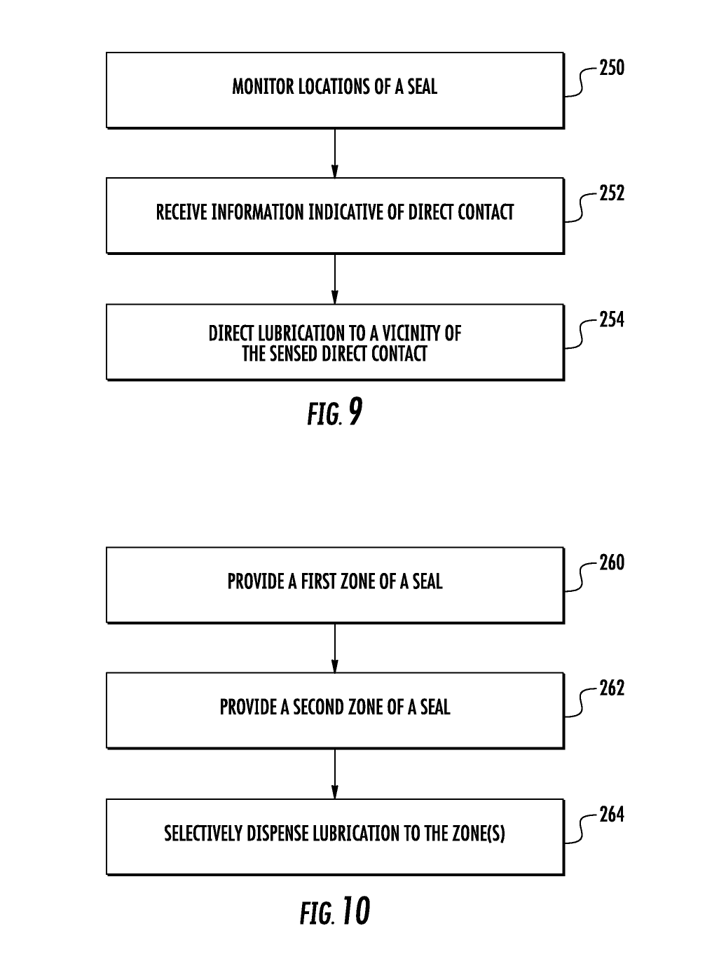

FIG. 9 is a flowchart depicting functionality associated with an example embodiment of a method for sealing. As shown in FIG. 9, the functionality (or method) may be construed as beginning at block 250, in which locations of a seal formed between a sealing element and an inner surface of a rotatable perforated drum are monitored. In particular, one or more sensors may be used to monitor one or more operating parameters of a paper-processing operation. For instance, if pressure and/or temperature sensors are used, pressure and/or temperature along the length of the seal could be monitored with relative differences sensed along the length being indicative of areas of contact between the seal and the suction roll.

In block 252, information indicative of direct contact between the sealing element and the inner surface of the suction roll is received. By way of example, the information may be in the form of electrical signals transmitted from the sensor to a corresponding controller that incorporates control circuitry. Responsive to the information (such as depicted in block 254), lubrication is directed to a vicinity of the seal indicated to alleviate the direct contact. In some embodiments, this may involve actuation of one or more control actuators to initiate and/or vary flow of lubricant to one or more zones of the sealing element.

In this regard, another example embodiment of a method for sealing is depicted in the flowchart of FIG. 10. As shown in FIG. 10, a first zone and a second zone are provided (blocks 260 and 262, respectively) for a seal that is formed between a sealing element and an inner surface of a rotatable perforated drum. In block 264, lubrication is selectively dispensed to at least one of the first zone and the second zone.

In other embodiments, a sealing method may involve: providing a first zone of a seal formed between a sealing element and an inner surface of a rotatable perforated drum; providing a second zone of the seal, wherein the first zone and the second zone are not coextensive; and, selectively dispensing lubrication to at least one of the first zone and the second zone. Notably, the selective dispensing may involve varying a flow rate of the lubrication (e.g., on or off, or metering the flow rate) to the zone(s) such that the flow rates of the zones vary. Additionally, the dispensing may be provided by one or more lubrication showers configured to service multiple zones, one or more lubrication outlets configured to service multiple zones, and combinations thereof.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A sealing system for use within an interior chamber of a perforated drum rotatable about a rotational axis, the sealing system comprising:
an elongated seal having a contact surface configured to form an airtight seal with an inner surface of the drum;
contact sensor circuitry configured to provide an electrical signal containing information indicative of direct contact between the seal and the inner surface of the drum; and
a control actuator configured to direct a flow of lubricant responsive to the contact sensor indicating the direct contact such that the flow of lubricant forms a film of lubricant between the contact surface and the inner surface of the drum to prevent direct contact between the seal and the drum.

2. The system of claim 1, further comprising control circuitry, communicating with the control actuator, configured to actuate the control actuator for directing the flow of lubricant, the control circuitry being operative to actuate the control actuator responsive to receiving the information from the contact sensor indicating direct contact.

3. The system of claim 1, wherein the contact sensor circuitry comprises a temperature sensor.

4. The system of claim 1, wherein the contact sensor circuitry comprises a pressure sensor.

5. The system of claim 1, wherein the contact sensor circuitry comprises a proximity sensor.

6. The system of claim 1, wherein the contact sensor circuitry comprises a vacuum sensor.

7. The system of claim 1, wherein the elongated seal has a contact surface, a lubrication outlet, and a lubrication passage, the lubrication outlet being positioned along the contact surface and configured to dispense lubricant therefrom, the lubrication passage communicating with the lubrication outlet and being configured to provide the lubrication outlet with a flow of the lubricant such that the lubricant dispensed from the lubrication outlet forms the film of lubricant between the contact surface and the inner surface of the drum in a vicinity of the lubrication outlet.

8. The system of claim 1, wherein:
the lubrication outlet is a first lubrication outlet configured to dispense lubrication at a first zone of the contact surface; and
the seal further comprises a second lubrication outlet configured to dispense lubrication at a second zone of the contact surface.

9. The system of claim 1, further comprising a lubrication shower positioned rotationally upstream of the contact surface, the lubrication shower being configured to provide a flow of the lubricant rotationally upstream of the contact surface such that the lubricant dispensed from the lubrication shower forms the film of lubricant between a first zone of the contact surface and the inner surface of the drum.

10. The system of claim 9, wherein the lubrication shower is further configured to selectively dispense lubrication at a second zone of the contact surface.

11. The system of claim 1, wherein:
the seal has a first zone and a non-coextensive second zone; and
the control actuator is operative to direct flows of lubricant responsive to the contact sensor indicating the direct contact such that a flow rate of the lubricant provided to the first zone differs from a flow rate of the lubricant provided to the second zone.

12. The system of claim 1, further comprising a suction roll within which the elongated seal is mounted, the suction roll having holes formed therethrough.

13. The system of claim 12, further comprising a vacuum box mounted within the suction roll and operative to direct vacuum pressure through the holes of the suction roll.

14. A sealing method comprising:
monitoring locations of a seal formed between a sealing element and an inner surface of a rotatable perforated drum;
receiving information indicative of direct contact between the sealing element and the inner surface; and
responsive to the information, directing lubrication to a vicinity of the seal to alleviate the direct contact.

15. The method of claim 14, wherein directing lubrication comprises directing a spray of lubrication to a zone located rotationally upstream of the sealing element.

16. The method of claim 14, wherein directing lubrication comprises directing a flow of lubrication through at least a portion of the sealing element.

17. A sealing method comprising:
providing a first zone of a seal formed between a sealing element and an inner surface of a rotatable perforated drum;
providing a second zone of the seal, wherein the first zone and the second zone are not coextensive; and
selectively dispensing lubrication to at least one of the first zone and the second zone.

18. The method of claim 17, wherein, in selectively dispensing the lubrication, a flow rate of the lubrication provided to the first zone differs from a flow rate of the lubrication provided to the second zone.
